(19) United States
(12) Patent Application Publication
(10) Pub. No.: US 2020/0166715 A1
(43) Pub. Date: May 28, 2020

(54) CONNECTOR PLUG, OPTICAL CONNECTOR, AND OPTICAL CONNECTION STRUCTURE

(71) Applicant: SUMITOMO ELECTRIC INDUSTRIES, LTD., Osaka-shi (JP)

(72) Inventors: Osamu SHIMAKAWA, Osaka-shi (JP); Takuro WATANABE, Osaka-shi (JP)

(73) Assignee: SUMITOMO ELECTRIC INDUSTRIES, LTD., Osaka-shi (JP)

(21) Appl. No.: 16/775,995

(22) Filed: Jan. 29, 2020

Related U.S. Application Data
(63) Continuation of application No. PCT/JP2018/020541, filed on May 29, 2018.

(30) Foreign Application Priority Data
Aug. 30, 2017 (JP) 2017-165969

(51) Int. Cl. G02B 6/38

(52) U.S. Cl. CPC G02B 6/3869

(57) ABSTRACT

A connector plug according to an embodiment includes a flange attached to a ferrule of an optical connector, a plug frame containing the flange, and a first spring and a second spring interposed between the flange and the plug frame. The flange has outer surfaces, the plug frame has inner surfaces, the first spring is interposed between the outer surface and the inner surface, the second spring is interposed between the outer surface and the inner surface, the outer surface and the inner surface are in contact with each other, and the outer surface and the inner surface are in contact with each other.

### CROSS-REFERENCE TO RELATED APPLICATIONS

This application is a continuation application of PCT/JP2018/020541 claiming the benefit of priority of the Japanese Patent Application No. 2017-165969 filed on Aug. 30, 2017, the entire contents of which are incorporated herein by reference.

### TECHNICAL FIELD

One aspect of the present invention relates to a connector plug, an optical connector, and an optical connection structure.

### BACKGROUND ART

Various types of connector plugs, optical connectors, and optical connection structures are known heretofore. Patent Literature 1 discloses an optical connector plug for a polarization-maintaining fiber configured to prevent misalignment with respect to an axis rotation direction when polarization-maintaining fibers are connected to each other. The optical connector plug includes a ferrule that holds an optical fiber, a flange portion to the ferrule, and a plug housing that houses the ferrule and the flange portion. A coupling member is fitted to the flange portion and comes into contact with inner surfaces of the plug housing to prevent the misalignment.

Patent Literature 2 discloses an optical coupler for a multicore fiber configured to prevent misalignment with respect to an axis rotation direction when multicore fibers are connected to each other. The optical coupler includes a ferrule that holds a multicore fiber and a plug frame that houses the ferrule. The ferrule has at least one flat surface on its outer periphery, and the plug frame has a leaf spring structure that presses the flat surface. The leaf spring structure is integrally formed with the plug frame inside the plug frame.

### CITATION LIST

### Patent Literature

Patent Literature 1: Japanese Unexamined Patent Publication No. H10-90558

Patent Literature 2: Japanese Unexamined Patent Publication No. 2014-182229

### SUMMARY OF INVENTION

A connector plug according to an embodiment is a connector plug for use in an optical connector configured to connect optical fibers, the connector plug including a flange attached to a ferrule of the optical connector, a plug frame containing the flange, and a first spring and a second spring interposed between the flange and the plug frame. In the connector plug, the flange has a first outer surface, a second outer surface, a third outer surface on a side of the flange opposite from the first outer surface, and a fourth outer surface on a side of the flange opposite from the second outer surface, the plug frame has a first inner surface, a second inner surface, a third inner surface facing the first inner surface, and a fourth inner surface facing the second inner surface, the first spring is interposed between the first outer surface and the first inner surface, the second spring is interposed between the second outer surface and the second inner surface, the third outer surface and the third inner surface are in contact with each other, and the fourth outer surface and the fourth inner surface are in contact with each other.

An optical connector according to an embodiment is an optical connector including the above-described connector plug, the optical connector including an optical fiber having a distal end surface from which a core is exposed, a ferrule having an optical fiber holding hole and a connection end surface, the optical fiber holding hole holding the optical fiber, and a third spring configured to press the ferrule with the flange interposed between the third spring and the ferrule. In the optical connector, the optical fiber is inserted into the optical fiber holding hole and held with the distal end surface exposed from the connection end surface, the flange holds the ferrule by containing a part of the ferrule located away from the connection end surface in an optical connection direction, and the third spring is a helical spring configured to press the flange from a side of the flange away from the connection end surface in the optical connection direction.

An optical connection structure according to an embodiment includes the above-described connector plug or the above-described optical connector.

### BRIEF DESCRIPTION OF DRAWINGS

FIG. 1 is a perspective view of an optical connector according to a first embodiment.

FIG. 2 is a side cross-sectional view of the optical connector shown in FIG. 1.

FIG. 3 is a perspective view of a part of an optical connection structure between the optical connector shown in FIG. 1 and a mating connector.

FIG. 4 is a perspective view of a flange, a ferrule, and an optical fiber of the optical connector shown in FIG. 1.

FIG. 5 is a perspective cross-sectional view of a plug frame, the flange, the ferrule, and the optical fiber of the optical connector shown in FIG. 1.

FIG. 6 is a cross-sectional view of the flange and the plug frame shown in FIG. 5, taken along a plane intersecting four outer surfaces of the flange.

FIG. 7 is a perspective view of an optical connector according to a second embodiment.

FIG. 8 is a side cross-sectional view of the optical connector shown in FIG. 7.

FIG. 9 is a side view of a flange, a ferrule, and an optical fiber of the optical connector shown in FIG. 7.

FIG. 10 is a front view of the flange, the ferrule, and the optical fiber shown in FIG. 9.

FIG. 11 is a cross-sectional view of the plug frame and the flange of the optical connector shown in FIG. 7, taken along a plane intersecting four inner surfaces of the plug frame.

FIG. 12 is a front view of an optical connector according to a third embodiment.

FIG. 13 is a cross-sectional view of a flange and a plug frame taken along a plane intersecting six outer surfaces of a flange according to a modification.

### DESCRIPTION OF EMBODIMENTS

[Problem to be Solved by the Present Disclosure]

In the optical connector plug for the polarization-maintaining fiber described above, the coupling member is fitted to the flange portion, which makes the structure of the flange distinctive. Further, in this optical connector plug, the flange portion has a structure including the coupling member, which increases the number of components and requires that each component be machined with high accuracy. This leads to an increase in cost of the optical connector plug.

In the optical connector for a multicore fiber described above, each of the four inner walls of the plug frame surrounding the ferrule has a leaf spring structure, and the ferrule is held inside the four leaf spring structures. This may make the ferrule unstable in position, which causes concern that the ferrule is misaligned by rotation.

An object of one aspect of the present invention is to provide a connector plug, an optical connector, and an optical connection structure that can suppress an increase in cost and prevent a ferrule from being misaligned by rotation.

[Effects of the Present Disclosure]

According to one aspect of the present invention, it is possible to suppress an increase in cost and prevent a ferrule from being misaligned by rotation.

[Description of Embodiments]

First, descriptions will be given in series of the contents of embodiments of the present invention. A connector plug according to an embodiment is a connector plug for use in an optical connector configured to connect optical fibers, the connector plug including a flange attached to a ferrule of the optical connector, a plug frame containing the flange, and a first spring and a second spring interposed between the flange and the plug frame. In the connector plug, the flange has a first outer surface, a second outer surface, a third outer surface on a side of the flange opposite from the first outer surface, and a fourth outer surface on a side of the flange opposite from the second outer surface, the plug frame has a first inner surface, a second inner surface, a third inner surface facing the first inner surface, and a fourth inner surface facing the second inner surface, the first spring is interposed between the first outer surface and the first inner surface, the second spring is interposed between the second outer surface and the second inner surface, the third outer surface and the third inner surface are in contact with each other, and the fourth outer surface and the fourth inner surface are in contact with each other.

An optical connector according to an embodiment is an optical connector including the above-described connector plug, the optical connector including an optical fiber having a distal end surface from which a core is exposed, a ferrule having an optical fiber holding hole and a connection end surface, the optical fiber holding hole holding the optical fiber, and a third spring configured to press the ferrule with the flange interposed between the third spring and the ferrule. In the optical connector, the optical fiber is inserted into the optical fiber holding hole and held with the distal end surface exposed from the connection end surface, the flange holds the ferrule by containing a part of the ferrule located away from the connection end surface in an optical connection direction, and the third spring is a helical spring configured to press the flange from a side of the flange away from the connection end surface in the optical connection direction. Further, an optical connection structure according to an embodiment includes the above-described connector plug or the above-described optical connector.

The connector plug, the optical connector, and the optical connection structure include the ferrule that holds the optical fiber, the flange attached to the ferrule, and the plug frame that contains the flange. The flange has the first outer surface, the second outer surface, the third outer surface, and the fourth outer surface, and the plug frame has the first inner surface, the second inner surface, the third inner surface, and the fourth inner surface. Accordingly, none of the ferrule, the flange, and the plug frame has a special shape, making it possible to suppress an increase in the number of components and in turn suppress an increase in cost. Further, the first spring is interposed between the first outer surface and the first inner surface, and the second spring is interposed between the second outer surface and the second inner surface. On the other hand, the third outer surface and the third inner surface are in contact with each other, and the fourth outer surface and the fourth inner surface are in contact with each other. Accordingly, among the four pairs of outer surfaces and inner surfaces, the springs are each provided between a corresponding one of first pairs, and second pairs are each in contact with each other. This causes the flange and the ferrule to be held movable by the first and second springs relative to the plug frame, allowing the ferrule to float. Further, the springs are each interposed between a corresponding one of the first pairs facing each other, and the second pairs facing each other are each brought into contact with each other, so that the springs between the first pairs each reliably press a corresponding one of the second pairs by pressing force, making it possible to reliably prevent the flange and the ferrule from rotating relative to the plug frame. This in turn makes the ferrule stable in position and makes it possible to prevent the ferrule from being misaligned by rotation.

Further, the first spring may be a leaf spring integrally formed with the first outer surface. In this configuration, the first spring is integrally formed with the flange, so that it is possible to suppress an increase in the number of components of the flange. This in turn makes it possible to suppress an increase in cost.

Further, the first spring may be a leaf spring integrally formed with the first inner surface. In this configuration, the first spring is integrally formed with the plug frame, so that it is possible to suppress an increase in the number of components of the plug frame. This in turn makes it possible to suppress an increase in cost.

Further, the first spring may be a spring formed separately from the first outer surface and the first inner surface. This configuration makes the flange and the plug frame simple in shape and in turn allows the flange and the plug frame to be easily formed.

Further, the second spring may be a leaf spring integrally formed with the second outer surface. In this configuration, the second spring is integrally formed with the flange, so that it is possible to suppress an increase in the number of components of the flange. This in turn makes it possible to suppress an increase in cost.

Further, the second spring may be a leaf spring integrally formed with the second inner surface. In this configuration, the second spring is integrally fanned with the plug frame, so that it is possible to suppress an increase in the number of components of the plug frame. This in turn makes it possible to suppress an increase in cost.

Further, the second spring may be a spring formed separately from the second outer surface and the second inner surface. This configuration makes the flange and the plug frame simple in shape and in turn allows the flange and the plug frame to be easily formed.

Further, the cross section of the flange taken along a plane intersecting the four outer surfaces may be quadrilateral. This configuration makes the flange simple in shape and in turn allows the flange to be easily formed.

Further, the cross section of the plug frame taken along a plane intersecting the four inner surfaces may be quadrilateral. This configuration makes the plug frame simple in shape and in turn allows the plug frame to be easily formed.

Further, the first inner surface may be located away from the center axis of the outer shape of the plug frame compared to the third inner surface, and the second inner surface is located away from the center axis of the outer shape of the plug frame compared to the fourth inner surface. This configuration makes the cross section of the plug frame taken along a plane intersecting the four inner surfaces asymmetrical. This allows, in the cross section, the flange holding the ferrule to be square and the center of the ferrule to coincide with the center axis of the plug frame.

Further, the flange has the ferrule holding hole holding the ferrule, and the first outer surface may be located close to the center axis of the ferrule holding hole compared to the third outer surface, and the second outer surface may be located close to the center axis of the ferrule holding hole compared to the fourth outer surface. This configuration makes the cross section of the flange taken along a plane intersecting the four outer surfaces of the flange asymmetrical. This allows, in the cross section, the plug frame holding the flange to be square and the center axis of the plug frame to coincide with the center of the ferrule held by the flange.

Further, for the optical connector described above, the optical fiber may be a multicore fiber or a polarization-maintaining fiber. This configuration makes it possible to prevent the multicore fiber or the polarization-maintaining fiber that requires a floating structure from being misaligned by rotation.

[Details of Embodiments]

Hereinafter, a description will be given of specific examples of the connector plug (floating structure), the optical connector, and the optical connection structure according to the embodiments with reference to the drawings. It should be noted that the present invention is not limited to the following examples, and is intended to be defined by the claims and to include all modifications within the scope of the claims and their equivalents. Note that, in the following description, the same or equivalent components are denoted by the same reference numerals, and any redundant description will be omitted as appropriate. Further, the drawings may be simplified or exaggerated in part for ease of understanding, and dimensional ratios and the like are not limited to those described in the drawings.

### First Embodiment

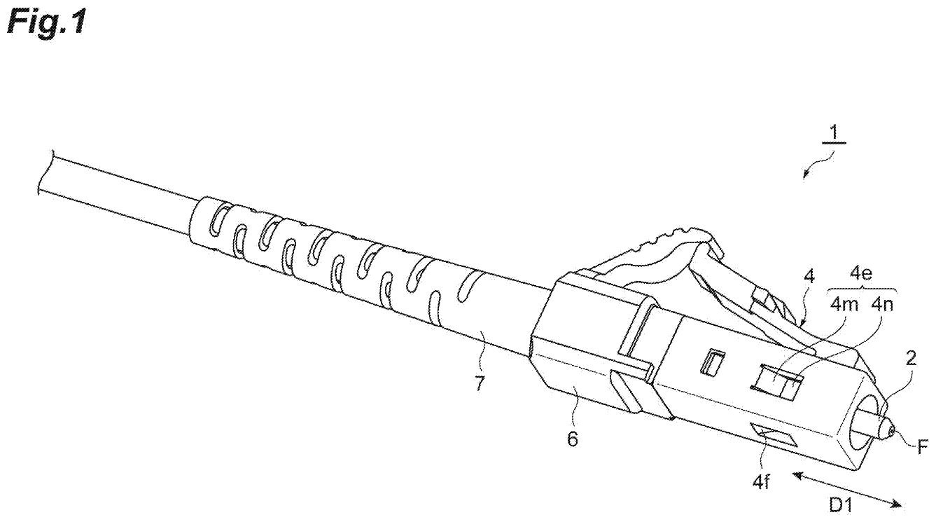

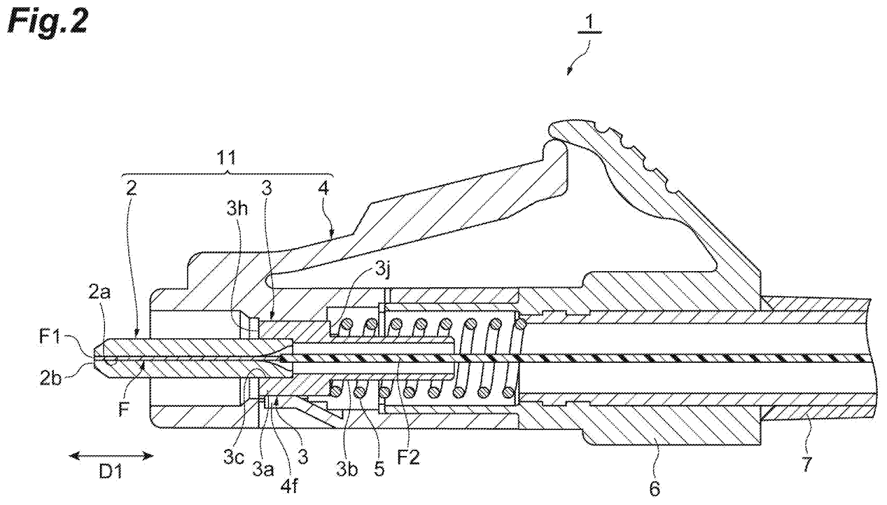

FIG. 1 is a perspective view of an optical connector 1 according to a first embodiment. FIG. 2 is a side cross-sectional view of the optical connector 1. The optical connector 1 is connected to a mating connector in a direction D1 serving as an optical connection direction with an adapter interposed between the optical connector 1 and the mating connector. The optical connector 1 connects optical fibers. According to the present embodiment, the optical connector 1 is an LC connector.

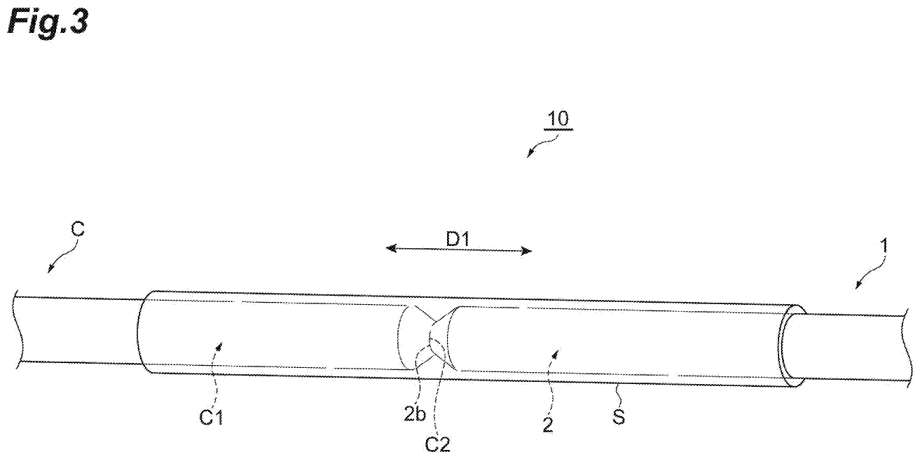

The optical connector 1 includes a ferrule 2 that holds an optical fiber F, a flange 3 that holds the ferrule 2 by containing a part of the ferrule 2, a plug frame 4 serving as a housing that contains the flange 3, and a helical spring 5 (third spring) that presses the ferrule 2 with the flange 3 interposed between the helical spring 5 and the ferrule 2. The optical connector 1 further includes a rear housing 6 provided away from the plug frame 4 in a direction D1 relative to the helical spring 5, and a boot 7 extending from the rear housing 6 in a direction away from the ferrule 2. As shown in FIG. 1 to FIG. 3, the ferrule 2 has a rod shape extending in the direction DI. FIG. 3 is a perspective view of a part of an optical connection structure 10 between the optical connector 1 and a mating connector C. The optical connector 1 includes a connector plug 11 according to the present embodiment and the optical fiber F, and the connector plug 11 includes the ferrule 2, the flange 3, and the plug frame 4.

The ferrule 2 has an optical fiber holding hole 2a extending in the direction D1. The ferrule 2 has a connection end surface 2b at one end of the ferrule 2 in the direction D1, the connection end surface 2b being configured to come into contact with a ferrule C1 of the mating connector C. On the connection end surface 2b, a distal end surface F1 of the optical fiber F is exposed, and a core of the optical fiber F is exposed from the distal end surface F1. According to the present embodiment, the optical fiber F is, for example, a polarization-maintaining fiber.

The mating connector C is identical in configuration to the optical connector 1, for example. In the optical connection structure 10, the optical connector 1 is optically connected to the mating connector C when the connection end surface 2b of the ferrule 2 comes into contact with a contact end surface C2 of the ferrule C1 of the mating connector C. The ferrule 2 and ferrule C1 are connected to each other with a split sleeve S. In the optical connection structure 10, both the ferrule 2 and the ferrule C1 are inserted into the split sleeve S, and the ferrule 2 is pressed against the ferrule C1 by pressing force of the helical spring 5 to cause the optical connector 1 and the mating connector C to be optically connected to each other.

The ferrule 2 is housed in the plug frame 4. The ferrule 2 is floating (movable) in the plug frame 4. This prevents, even when external force is applied to the plug frame 4, the force from acting directly on the ferrule 2 and the ferrule C1. This in turn prevents the ferrule 2 and the ferrule C1 from being misaligned.

The flange 3 is attached to the ferrule 2. The flange 3 is made of resin or metal. The flange 3 has a tubular shape extending in the direction D1 and has a diameter-enlarged section 3a and a diameter-reduced section 3b, the diameter-enlarged section 3a being located adjacent to the connection end surface 2b in the direction D1, the diameter-reduced section 3b being located away from the connection end surface 2b in the direction D1 relative to the diameter-enlarged section 3a. The ferrule 2 is held by the diameter-enlarged section 3a, and the optical fiber F is inserted into the optical fiber holding hole 2a from a side of the ferrule 2 away from the connection end surface 2b.

The optical fiber F inserted into the optical fiber holding hole 2a is held with the distal end surface F1 exposed from the connection end surface 2b. The optical fiber F inserted into the optical fiber holding hole 2a is a bare fiber. Specifically, a part of the optical fiber F that is not inserted into the optical fiber holding hole 2a and extends from the ferrule 2 in a direction away from the connection end surface 2b is covered by a resin film F2, and a part of the optical fiber F that is inserted into the optical fiber holding hole 2a is a bare fiber from which the resin film F2 has been removed.

The flange 3 has a ferrule holding hole 3e holding the ferrule 2. The flange 3 holds the ferrule 2 by containing a part of the ferrule 2 located away from the connection end surface 2b in the direction D1. The diameter-reduced section 3b of the flange 3 is inserted into the helical spring 5, and the helical spring 5 presses the flange 3 from a side of the flange 3 away from the connection end surface 2b in the direction D1.

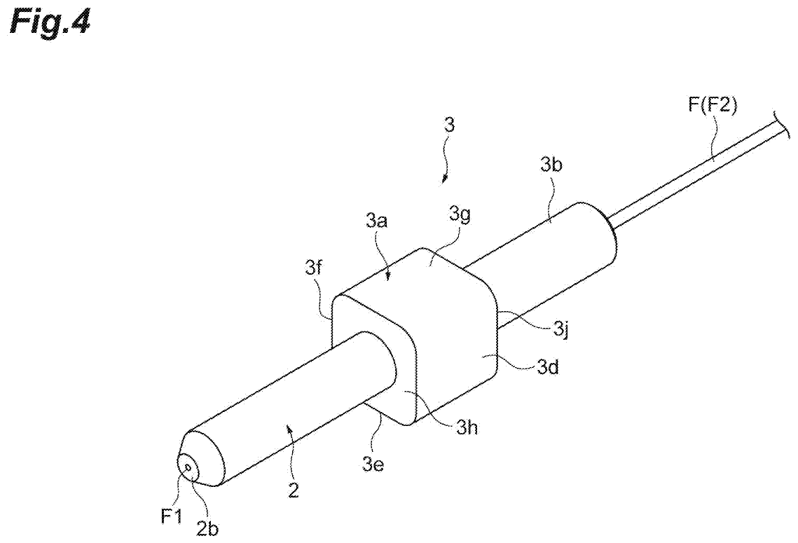

As shown in FIG. 4, the diameter-enlarged section 3a of the flange 3 is enlarged in diameter into a quadrilateral. Specifically, the diameter-enlarged section 3a has a quadrilateral shape with rounded corners and has a rectangular prism shape as a whole. The diameter-enlarged section 3a has a first outer surface 3d, a second outer surface 3e intersecting the first outer surface 3d, a third outer surface 3f on a side of the diameter-enlarged section 3a opposite from the first outer surface 3d, a fourth outer surface 3g on a side of the diameter-enlarged section 3a opposite from the second outer surface 3e, a fifth outer surface 3h from which the ferrule 2 protrudes, and a sixth outer surface 3j from which the diameter-reduced section 3b protrudes.

The first outer surface 3d and the second outer surface 3e are adjacent to each other, and the third outer surface 3f and the fourth outer surface 3g are adjacent to each other. Further, the diameter-reduced section 3b has a tubular shape and protrudes from the sixth outer surface 3j to a side away from the ferrule 2. The optical fiber F is inserted through the diameter-reduced section 3b.

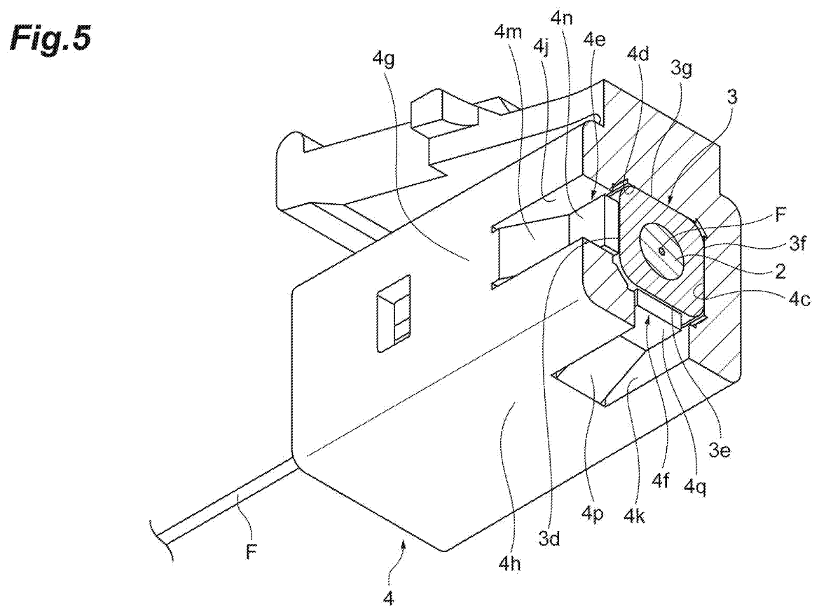

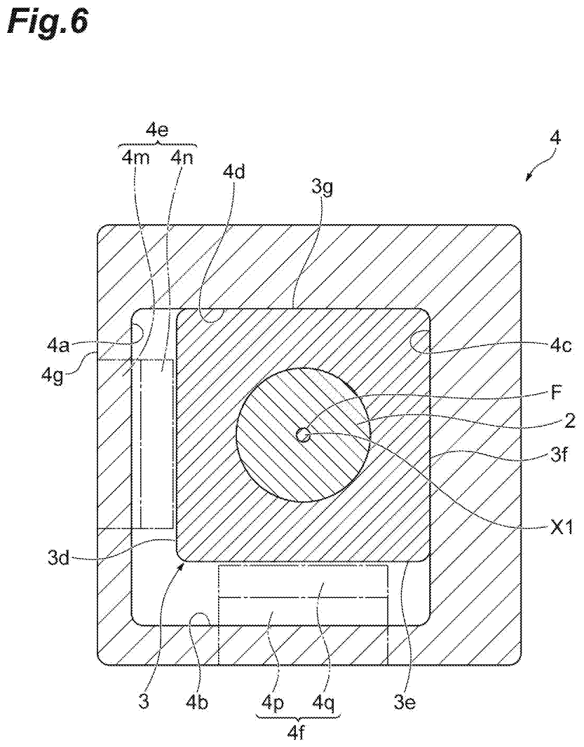

FIG. 5 is a perspective cross-sectional view of the flange 3 and the plug frame 4. FIG. 6 is a cross-sectional view of the flange 3 and the plug frame 4 taken along a plane intersecting the first to fourth outer surfaces 3d, 3e, 3f, 3g of the flange 3. As shown in FIG. 5 and FIG. 6, the flange 3 is contained in the plug frame 4.

The plug frame 4 includes a first inner surface 4a, a second inner surface 4b intersecting the first inner surface 4a, a third inner surface 4c facing the first inner surface 4a, and a fourth inner surface 4d facing a second inner surface 4b. The first inner surface 4a and the second inner surface 4b are adjacent to each other, and the third inner surface 4c and the fourth inner surface 4d are adjacent to each other.

The plug frame 4 includes a first spring 4e and a second spring 4f, in a cross section of the plug frame 4 taken along a plane intersecting the first to fourth inner surfaces 4a, 4b, 4c, 4d, the first spring 4e being interposed between the first outer surface 3d and the first inner surface 4a, the second spring 4f being interposed between the second outer surface 3e and the second inner surface 4b.

The plug frame 4 has an outer surface 4g on a side of the plug frame 4 opposite from the first inner surface 4a and an outer surface 4h on a side of the plug frame 4 opposite from the second inner surface 4b, and through holes 4j, 4k are formed through the outer surfaces 4g, 4h, respectively. The first spring 4e and the second spring 4f extends from inner edges of the through holes 4j, 4k, respectively. The first spring 4e is a leaf spring having an inclined section 4m extending obliquely from the outer surface 4g toward an inside of the plug frame 4 and a contact section 4n that comes into contact with the first outer surface 3d. The second spring 4f is also a leaf spring having a similar inclined section 4p and contact section 4q.

The third outer surface 3f of the flange 3 is in surface contact with the third inner surface 4c of the plug frame 4, and the fourth outer surface 3g is in surface contact with the fourth inner surface 4d. A cross section of the flange 3 taken along a plane intersecting the four outer surfaces 3d, 3e, 3f, 3g of the flange 3, and a cross-section of the plug frame 4 taken along a plane intersecting the four inner surfaces 4a, 4b, 4c, 4d of the plug frame 4 are both quadrilateral.

In the cross section described above, a center axis X1 of an outer shape of the plug frame 4 coincides with a center of the ferrule 2, and thus the plug frame 4 is asymmetrical. The first inner surface 4a is located away from the center axis X1 compared to the third inner surface 4c, and the second inner surface 4b is located away from the center axis X1 compared to the fourth inner surface 4d. A part of the plug frame 4 where the first inner surface 4a and the second inner surface 4b are fanned is thinner than a part of the plug frame 4 where the third inner surface 4c and the fourth inner surface 4d are formed.

Next, a description will be given of actions and effects obtained from the connector plug 11, the optical connector 1, and the optical connection structure 10 according to the present embodiment.

The connector plug 11, the optical connector 1, and the optical connection structure 10 include the ferrule 2 that holds the optical fiber F, the flange 3 attached to the ferrule 2, and the plug frame 4 that contains the flange 3. The flange 3 has the first outer surface 3d, the second outer surface 3e, the third outer surface 3f, and the fourth outer surface 3g, and the plug frame 4 has the first inner surface 4a, the second inner surface 4b, the third inner surface 4c, and the fourth inner surface 4d. Accordingly, none of the ferrule 2, the flange 3, and the plug frame 4 has a special shape, making it possible to suppress an increase in the number of components and in turn suppress an increase in cost.

Further, the first spring 4e is interposed between the first outer surface 3d and the first inner surface 4a, and the second spring 4f is interposed between the second outer surface 3e and the second inner surface 4b. On the other hand, the third outer surface 3f and the third inner surface 4c are in contact with each other, and the fourth outer surface 3g and the fourth inner surface 4d are in contact with each other. Accordingly, among the four pairs of the outer surfaces 3d, 3e, 3f, 3g and the inner surfaces 4a, 4b, 4c, 4d, the springs 4e, 4f are each provided between a corresponding one of first pairs, and second pairs are each in contact with each other. This causes the flange 3 and the ferrule 2 to be held movable by the springs 4e, 4f relative to the plug frame 4, allowing the ferrule 2 to float.

Further, the springs 4e, 4f are each interposed between a corresponding one of the first pairs facing each other, and the second pairs facing each other are each brought into contact with each other, so that the springs 4e, 4f between the first pairs each reliably press a corresponding one of the second pairs by pressing force, making it possible to reliably prevent the flange 3 and the ferrule 2 from rotating relative to the plug frame 4. This in turn makes the ferrule 2 stable in position and makes it possible to prevent the ferrule 2 from being misaligned by rotation.

Further, the first spring 4e is a leaf spring integrally formed with the first inner surface 4a. That is, the first spring 4e is integrally formed with the plug frame 4, so that it is possible to suppress an increase in the number of components of the plug frame 4. This in turn makes it possible to suppress an increase in cost.

The second spring 4f is a leaf spring integrally formed with the second inner surface 4b. That is, the second spring 4f is integrally formed with the plug frame 4, so that it is possible to suppress an increase in the number of components of the plug frame 4. This in turn makes it possible to suppress an increase in cost.

Further, the cross section of the flange 3 taken along a plane intersecting the four outer surfaces 3d, 3e, 3f, 3g of the flange 3 is quadrilateral. This makes the flange 3 simple in shape and in turn allows the flange 3 to be easily formed.

Further, the cross section of the plug frame 4 taken along a plane intersecting the four inner surfaces 4a, 4b, 4c, 4d of the plug frame 4 is quadrilateral. This makes the plug frame 4 simple in shape and in turn allows the plug frame 4 to be easily formed.

Further, the first inner surface 4a is located away from the center axis X1 of the outer shape of the plug frame 4 compared to the third inner surface 4c, and the second inner surface 4b is located away from the center axis X1 compared to the fourth inner surface 4d. Therefore, the cross section of the plug frame 4 taken along a plane intersecting the four inner surfaces 4a, 4b, 4c, 4d of the plug frame 4 is asymmetrical.

This allows, in the cross section, the flange 3 holding the ferrule 2 to be square and the center of the ferrule 2 to coincide with the center axis X1 of the plug frame 4.

Further, in the optical connector 1, the optical fiber F is a polarization-maintaining fiber. It is possible to prevent the polarization-maintaining fiber that requires a floating structure from being misaligned by rotation.

### Second Embodiment

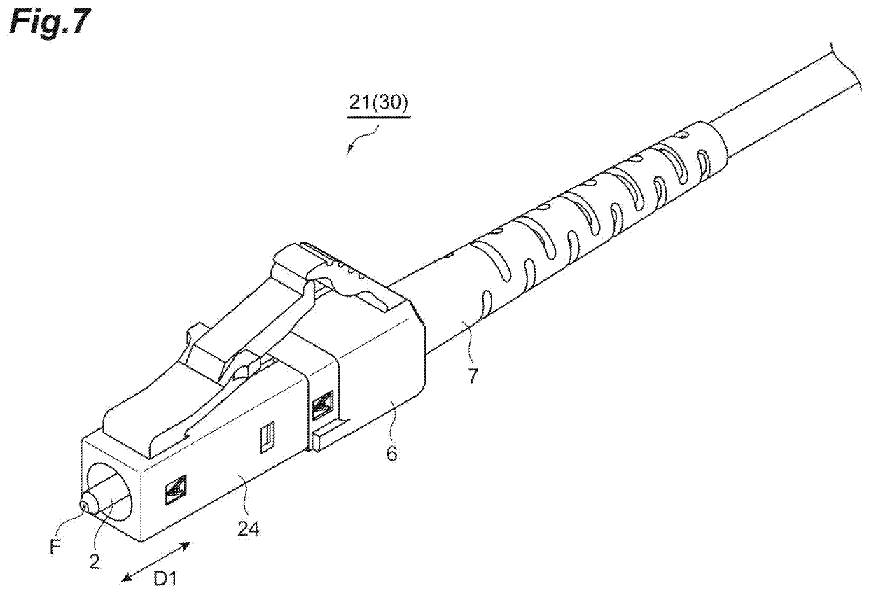

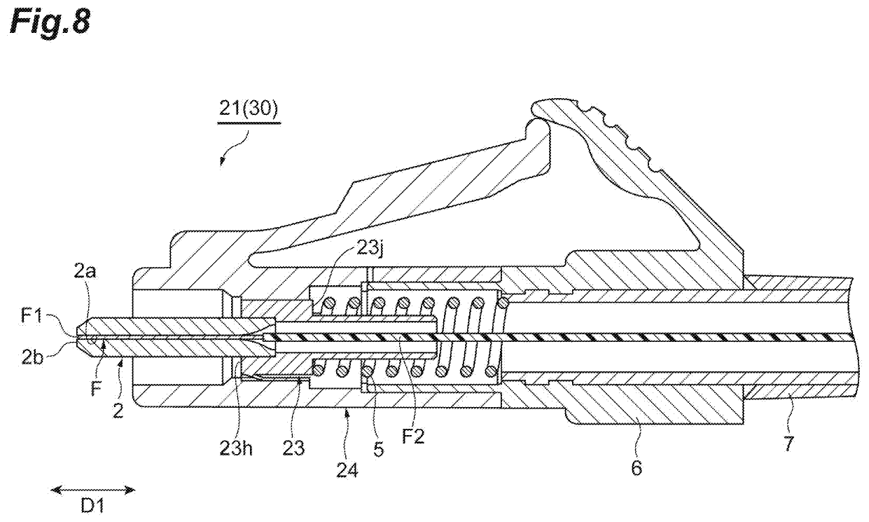

Next, a description will be given of a connector plug 30 and an optical connector 21 according to a second embodiment with reference to FIG. 7 to FIG. 11. FIG. 7 is a perspective view of the optical connector 21 according to the second embodiment. FIG. 8 is a side cross-sectional view of the optical connector 21. As shown in FIG. 7 and FIG. 8, the connector plug 30 includes a ferrule 2, a flange 23, and a plug frame 24, as with the connector plug 11 according to the first embodiment. In the following description, any redundant description that has been already given for the first embodiment will be omitted as appropriate.

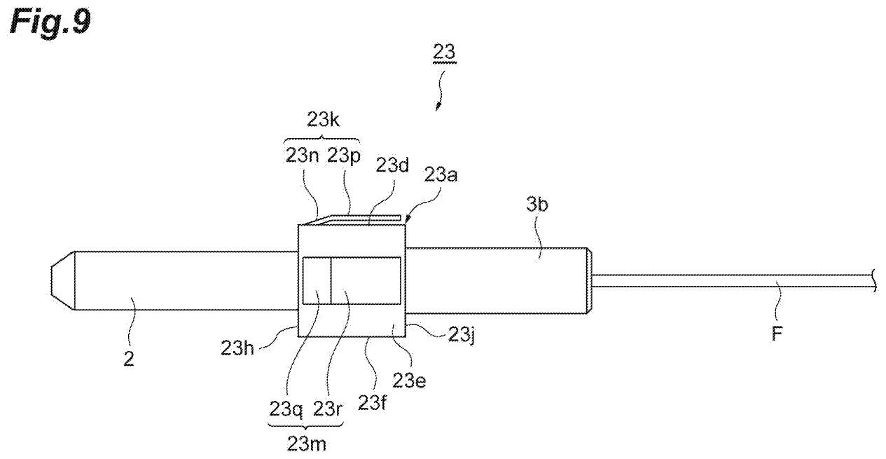

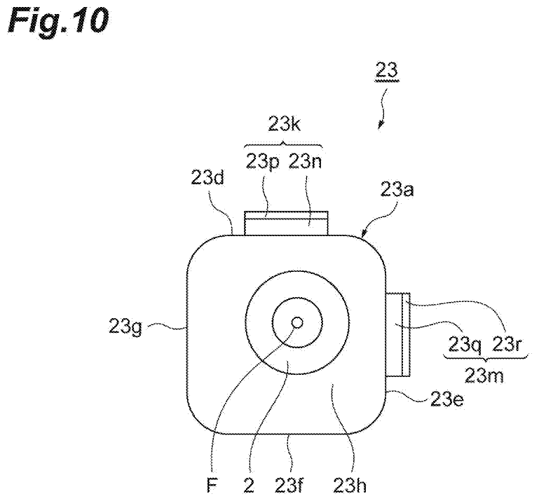

The flange 23 is attached to the ferrule 2. As shown in FIG. 9 and FIG. 10, the flange 23 has a diameter-enlarged section 23a and a diameter-reduced section 3b, and the diameter-enlarged section 23a is enlarged in diameter into a quadrilateral. The diameter-enlarged section 23a has a first outer surface 23d, a second outer surface 23e intersecting the first outer surface 23d, a third outer surface 23f on a side of the diameter-enlarged section 23a opposite from the first outer surface 23d, a fourth outer surface 23g on a side of the diameter-enlarged section 23a opposite from the second outer surface 23e, a fifth outer surface 23h from which the ferrule 2 protrudes, and a sixth outer surface 23j from which the diameter-reduced section 3b protrudes.

The flange 23 has a first spring 23k extending from the first outer surface 23d, and a second spring 23m extending from the second outer surface 23e. The first spring 23k and the second spring 23m is made of resin or metal. When the flange 23 is made of resin, the first spring 23k and the second spring 23m can be integrally formed with the flange 23 by resin molding. Further, when the first spring 23k and the second spring 23m are made of metal, the first spring 23k and the second spring 23m are fixed to the flange 23 by post-machining, for example.

The first spring 23k has an inclined section 23n extending obliquely from the first outer surface 23d toward an outside of the flange 23, and a contact section 23p that comes into contact with the plug frame 24. The second spring 23m has a similar inclined section 23q and contact section 23r. The first spring 23k and the second spring 23m are both leaf springs, for example.

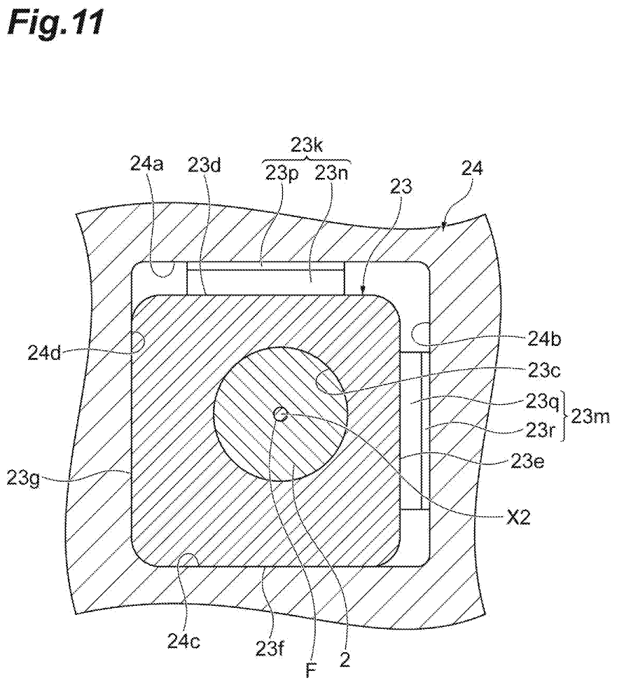

FIG. 11 is a cross-sectional view of the flange 23 and the plug frame 24 taken along a plane intersecting the four outer surfaces 23d, 23e, 23f, 23g of the flange 23. As shown in FIG. 11, the plug frame 24 has a first inner surface 24a, a second inner surface 24b intersecting the first inner surface 24a, a third inner surface 24c facing the first inner surface 24a, and a fourth inner surface 24d facing a second inner surface 24b. The first inner surface 24a, the second inner surface 24b, the third inner surface 24c, and the fourth inner surface 24d are all flat surfaces, for example. Further, the plug frame 24 does not have a configuration corresponding to the through holes 4j, 4k of the first embodiment and is thus made simple in shape compared to the plug frame 4.

In a cross section of the flange 23 and the plug frame 24 taken along a plane intersecting the four outer surfaces 23d, 23e, 23f, 23g of the flange 23, the first spring 23k is interposed between the first outer surface 23d and the first inner surface 24a, and the second spring 23m is interposed between the second outer surface 23e and the second inner surface 24b. In the cross section, the cross section of the flange 23 and the cross section of the plug frame 24 are both quadrilateral.

The first inner surface 24a of the plug frame 4 is pressed by the first spring 23k of the flange 23, and the second inner surface 24b is pressed by the second spring 23m. On the other hand, the third outer surface 23f is in surface contact with the third inner surface 24c, and the fourth outer surface 23g is in surface contact with the fourth inner surface 24d.

In the cross section described above, the flange 23 is asymmetric. The first outer surface 23d of the flange 23 is located close to a center axis X2 of a ferrule holding hole 23c of the flange 23 compared to the third outer surface 23f. The second outer surface 23e is located close to the center axis X2 compared to the fourth outer surface 23g.

That is, the center axis X2 of the ferrule holding hole 23c of the flange 23 is located closer to the first outer surface 23d and the second outer surface 23e. A part of the flange 23 including the first outer surface 23d and the second outer surface 23e is thinner than a part of the flange 23 including the third outer surface 23f and the fourth outer surface 23g.

As described above, in the connector plug 30 and the optical connector 21 according to the second embodiment, the first spring 23k is interposed between the first outer surface 23d of the flange 23 and the first inner surface 24a of the plug frame 24, and the second spring 23m is interposed between the second outer surface 23e and the second inner surface 24b. On the other hand, the third outer surface 23f and the third inner surface 24c are in contact with each other, and the fourth outer surface 23g and the fourth inner surface 24d are in contact with each other.

Accordingly, among the four pairs of the outer surfaces 23d, 23e, 23f, 23g and the inner surfaces 24a, 24b, 24c, 24d, the springs 23k, 23m are each provided between a corresponding one of first pairs, and second pairs are each in contact with each other. Therefore, the same effect as the effect of the first embodiment can be obtained. That is, this makes the ferrule 2 stable in position and makes it possible to prevent the ferrule 2 from being misaligned by rotation.

The first spring 23k is a leaf spring integrally formed with the first outer surface 23d. That is, the first spring 23k is integrally formed with the flange 23, so that it is possible to suppress an increase in the number of components of the flange 23. This in turn makes it possible to suppress an increase in cost. Further, the second spring 23m is a leaf spring integrally formed with the second outer surface 23e. That is, the second spring 23m is integrally formed with the flange 23, so that it is possible to suppress an increase in the number of components of the flange 23. This in turn makes it possible to suppress an increase in cost.

Further, the flange 23 has the ferrule holding hole 23c holding the ferrule 2, and the first outer surface 23d is located close to the center axis X2 of the ferrule holding hole 23c compared to the third outer surface 23f, and the second outer surface 23e is located close to the center axis X2 of the ferrule holding hole 23c compared to the fourth outer surface 23g.

Therefore, the cross section of the flange 23 taken along a plane intersecting the four outer surfaces 23d, 23e, 23f, 23g of the flange 23 is asymmetrical. This allows, in the cross section, the plug frame 24 holding the flange 23 to be square and the center axis of the plug frame 24 to coincide with the center (center axis X2) of the ferrule 2 held by the flange 23.

### Third Embodiment

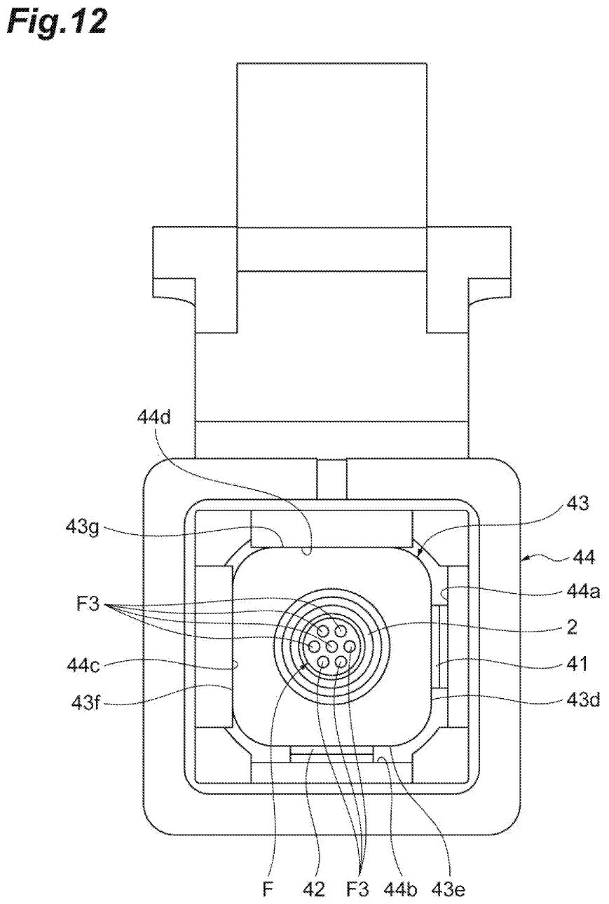

Next, a description will be given of a connector plug and an optical connector according to a third embodiment with reference to FIG. 12. The third embodiment is different from each the above-described embodiments in that springs 41, 42 are formed separately from a flange 43 and a plug frame 44 and that the optical fiber F is a multicore fiber including a plurality of cores F3.

The first spring 41 is interposed between a first outer surface 43d of the flange 43 and a first inner surface 44a of the plug frame 44 and is fox separately from the first outer surface 43d and the first inner surface 44a. The second spring 42 is interposed between a second outer surface 43e and a second inner surface 44b and is formed separately from the second outer surface 43e and the second inner surface 44b. For example, the first spring 41 and the second spring 42 are, for example, folded-back leaf springs and are interposed between the flange 43 and the plug frame 44. The first spring 41 and the second spring 42 may be made of metal or resin.

The first outer surface 43d, the second outer surface 43e, a third outer surface 43f, and a fourth outer surface 43g of the flange 43 are all flat surfaces, and the first inner surface 44a, the second inner surface 44b, a third inner surface 44c, and a fourth inner surface 44d of the plug frame 44 are all flat surfaces. The third outer surface 43f and the third inner surface 44c are in surface contact with each other, and the fourth outer surface 43g and the fourth inner surface 44d are in surface contact with each other. Further, the optical fiber F held by the ferrule 2 contained in the flange 43 includes, for example, seven cores F3, and six of the seven cores F3 are arranged in a regular hexagonal shape, and the rest of the seven cores F3 is disposed at the center of the regular hexagon.

As described above, according to the third embodiment, the first spring 41 is a spring formed separately from the first outer surface 43d and the first inner surface 44a. Further, the second spring 42 is a spring formed separately from the second outer surface 43e and the second inner surface 44b. This makes the flange 43 and the plug frame 44 simple in shape and in turn allows the flange 43 and the plug frame 44 to be easily formed.

Further, according to the third embodiment, among the four pairs of the outer surfaces 43d, 43e, 43f, 43g and the inner surfaces 44a, 44b, 44c, 44d, the springs 41, 42 are each provided between a corresponding one of first pairs, and second pairs are each in contact with each other. This makes the ferrule 2 stable in position and makes it possible to prevent the ferrule 2 from being misaligned by rotation as in each of the above-described embodiments. Therefore, it is possible to prevent the multicore fiber that requires a floating structure from being misaligned by rotation. This makes it possible to maintain the arrangement of the plurality of cores F3 of the multicore fiber and in turn makes it possible to suppress optical loss.

The connector plug (floating structure), the optical connector, and the optical connection structure according to the embodiments have been described above, but the connector plug, the optical connector, and the optical connection structure according to the present invention are not limited to the above-described embodiments and are allowed to be modified in various forms. That is, the configuration of each component of the connector plug, the optical connector, and the optical connection structure can be appropriately changed within the scope of the gist of the claims.

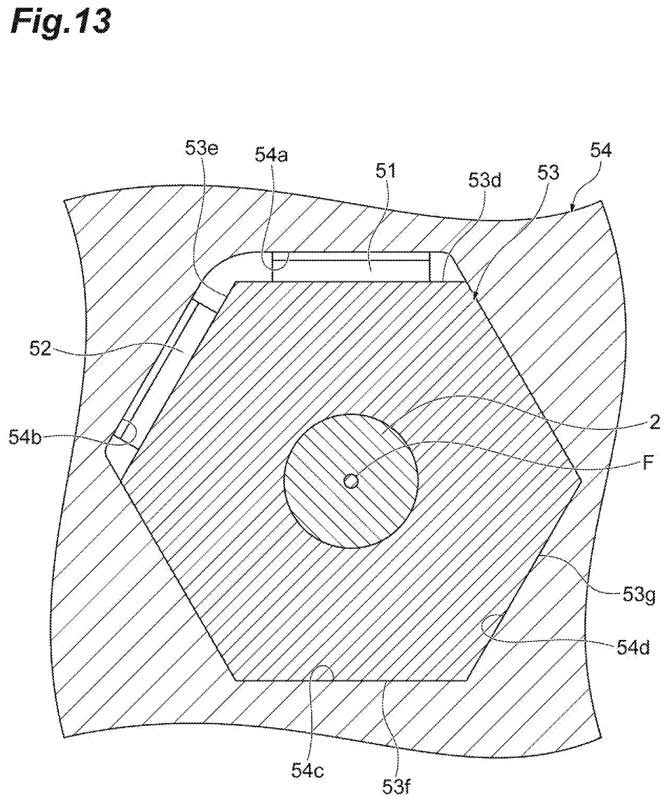

For example, the description has been given of the above-described embodiments in which the flange 3 and the plug frame 4 are quadrilateral in cross section, but the cross sections of the flange and the plug frame may have a shape other than a quadrilateral, such as a pentagon. For example, as shown in FIG. 13, a flange 53 and a plug frame 54 may be hexagonal in cross section.

In this configuration, a first spring 51 is interposed between a first outer surface 53d of a flange 53 and a first inner surface 54a of a plug frame 54, and a second spring 52 is interposed between a second outer surface 53e and a second inner surface 54b. On the other hand, a third outer surface 53f on a side of the flange 53 opposite from the first outer surface 53d and a third outer surface 54c facing the first inner surface 54a are in contact with each other, and a fourth outer surface 53g on a side of the flange 53 opposite from the second outer surface 53e and a fourth outer surfaces 54d facing the second inner surface 54b are in contact with each other. Accordingly, among the pairs of surfaces facing each other, the springs are each provided between a corresponding one of first pairs, and second pairs are each in contact with each other. Therefore, the same effect as the effect of each of the above-described embodiments can be obtained.

Further, according to the above-described embodiments, the plug frame 4 including the first spring 4e integrally formed with the first inner surface 4a and the second spring 4f integrally formed with the second inner surface 4b has been described. However, at least one of the first spring 4e and the second spring 4f may be formed separately from the plug frame 4 and the flange 3, or may be integrally formed with the flange 3.

Further, according to the above-described embodiments, the flange 23 including the first spring 23k integrally formed with the first outer surface 23d and the second spring 23m integrally formed with the second outer surface 23e has been described. However, at least one of the first spring 23k and the second spring 23m may be formed separately from the flange 23 and the plug frame 24, or may be integrally formed with the plug frame 24.

Further, according to the above-described embodiments, the example where the third outer surface 3f of the flange 3 is in surface contact with the third inner surface 4c of the plug frame 4, and the fourth outer surface 3g is in surface contact with the fourth inner surface 4d has been described. However unevenness may be formed on either the third inner surface or the third outer surface, and the third inner surface and the third outer surface may be in contact with each other via the unevenness. The same applies to the fourth inner surface and the fourth outer surface.

Further, according to the above-described embodiments, the optical connector 1 serving as an LC connector has been described. However, the optical connector may be an optical connector other than the LC connector, such as an FC connector, an SC connector, or an MU connector.

1. A connector plug for use in an optical connector configured to connect optical fibers, the connector plug comprising:
a flange attached to a ferrule of the optical connector;
a plug frame containing the flange; and
a first spring and a second spring interposed between the flange and the plug frame, wherein
the flange has a first outer surface, a second outer surface, a third outer surface on a side of the flange opposite from the first outer surface, and a fourth outer surface on a side of the flange opposite from the second outer surface,
the plug frame has a first inner surface, a second inner surface, a third inner surface facing the first inner surface, and a fourth inner surface facing the second inner surface,
the first spring is interposed between the first outer surface and the first inner surface,
the second spring is interposed between the second outer surface and the second inner surface,
the third outer surface and the third inner surface are in contact with each other, and
the fourth outer surface and the fourth inner surface are in contact with each other.

2. The connector plug according to claim 1, wherein
the first spring is a leaf spring integrally formed with the first outer surface.

3. The connector plug according to claim 1, wherein
the first spring is a leaf spring integrally formed with the first inner surface.

4. The connector plug according to claim 1, wherein
the first spring is a spring formed separately from the first outer surface and the first inner surface.

5. The connector plug according to claim 1, wherein
the second spring is a leaf spring integrally formed with the second outer surface.

6. The connector plug according to claim 1, wherein
the second spring is a leaf spring integrally formed with the second inner surface.

7. The connector plug according to claim 1, wherein
the second spring is a spring formed separately from the second outer surface and the second inner surface.

8. The connector plug according to claim 1, wherein
a cross section of the flange taken along a plane intersecting the four outer surfaces of the flange is quadrilateral.

9. The connector plug according to claim 1, wherein
a cross section of the plug frame taken along a plane intersecting the four inner surfaces of the plug frame is a quadrilateral.

10. The connector plug according to claim 1, wherein
the first inner surface is located away from a center axis of an outer shape of the plug frame compared to the third inner surface, and
the second inner surface is located away from the center axis of the outer shape of the plug frame compared to the fourth inner surface.

11. The connector plug according to claim 1, wherein
the flange has a ferrule holding hole holding the ferrule,
the first outer surface is located close to a center axis of the ferrule holding hole compared to the third outer surface, and
the second outer surface is located close to the center axis of the ferrule holding hole compared to the fourth outer surface.

12. An optical connector including the connector plug according to claim 1, the optical connector comprising:
an optical fiber having a distal end surface from which a core is exposed;
a ferrule having an optical fiber holding hole and a connection end surface, the optical fiber holding hole holding the optical fiber; and
a third spring configured to press the ferrule with the flange interposed between the third spring and the ferrule, wherein
the optical fiber is inserted into the optical fiber holding hole and held with the distal end surface exposed from the connection end surface,
the flange holds the ferrule by containing a part of the ferrule located away from the connection end surface in an optical connection direction, and
the third spring is a helical spring configured to press the flange from a side of the flange away from the connection end surface in the optical connection direction.

13. The optical connector according to claim 12, wherein the optical fiber is a multicore fiber or a polarization-maintaining fiber.

14. An optical connection structure comprising the connector plug according to claim 1.

15. An optical connection structure comprising the optical connector according to claim 12.
